(19) United States
(12) Patent Application Publication
(10) Pub. No.: US 2010/0072279 A1
(43) Pub. Date: Mar. 25, 2010

(54) REUSABLE GROCERY BAG FOR USE WITH OPTICAL PRODUCT IDENTIFIERS

(76) Inventor: Isabelle Spencer, Guelph (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/562,246

(22) Filed: Sep. 18, 2009

Related U.S. Application Data
(60) Provisional application No. 61/098,379, filed on Sep. 19, 2008.

(51) Int. Cl. G06K 7/10; B65D 30/06

(52) U.S. Cl. 235/454; 383/117; 235/462.01

(57) ABSTRACT

A reusable bag includes a fabric body having an interior volume and an opening that provides access to the interior volume. The fabric body including a plurality of threads oriented and spaced apart so as to form a net structure for securing at least one grocery product within the interior volume. At least a portion of the net structure is sized and shaped to allow an optical product identifier received in the interior volume and on or associated with the at least one grocery product to be optically identified through the net structure using an optical scanner.

### RELATED APPLICATIONS

This application claims the benefit of U.S. Provisional Application No. 61/098,379, filed on Sep. 19, 2008 and entitled REUSABLE PRODUCE BAG, the entire contents of which are hereby incorporated by reference.

### TECHNICAL FIELD

The embodiments herein relate in general to environmentally friendly packaging and more particularly to environmentally friendly and reusable grocery bags suitable for use with optical product identifiers.

### INTRODUCTION

Packaging that is environmentally friendly has become a growing concern in light of the limited resources now facing the world economies. As such there is increasing pressure to reuse traditional packaging wherever possible and to develop innovative packing to replace materials that may not be convenient for recycling or easily broken down in landfills.

In particular, the grocery sector faces unique challenges in light of the amount of packaging found not only with processed food but also with bags for securing produce and other grocery products and bags used for carrying groceries. Packaging for produce creates unique challenges with respect to the weight of the produce, the large variety of different types of produce, and the reusability of typical packaging for produce.

Various types of bags have been developed to address some of the problems. For example, U.S. Pat. No. 5,535,543 issued on Jul. 16, 1996 to Alexander relates to fruit or vegetables that are still maturing on a parent plant and the ability to protect them from damage due to soft freeze by enclosing the fruits or vegetables within a bag made of flexible, thermally insulating, water and air permeable material and that remains stable in prolonged sunlight. The bag is globular in shape and has a single elasticized opening. Examples of suitable bag materials include wool, acrylic, mod acrylic, polyester, polypropylene, and fiber blends containing these materials.

Cammack is the owner of U.S. Pat. No. 5,741,076 that issued on Apr. 21, 1998 and relates to a new produce bag for offering a more efficient and effective packaging method for fruits and vegetables. The device includes a bottom portion and a top portion joined to the bottom portion to form a tubular body defining a pair of superimposed panels in a flattened state, wherein the tubular body has an open top end and a closed bottom end. The bottom portion is made from a net material and the top portion is made from a sheet material, wherein the top portion is adapted for use with a standard automatic bag filling machine as well as a standard automatic bag closure machine.

U.S. Pat. No. 6,371,645 which issued on Apr. 16, 2002 to Rusert et al. relates to an open mesh bag comprising an open, mesh-like fabric. The bag has a closed end formed by a fold in the fabric, an opposing end and longitudinal, heat-sealed side seams extending from the closed end to the opposing end. The bags are used for packaging articles for which visibility and/or breathability of the bag fabric are useful characteristics. In a preferred embodiment, the bags are also suited for manufacture and filling using high speed, automated equipment.

Bruno is the owner of U.S. Pat. No. 3,768,643 which issued on Oct. 30, 1973 and relates to a net bag of the type in which produce is packaged, particularly bunches of grapes and the like, characterized by a novel closure at one end, the structure and location of which results in a snag-proof tail that allows the bags to be nested and removed one at a time. Bruno also encompasses the carrier for the nested bags which comprises an elongate bendable strap preferably of one-piece construction and folded over intermediate its ends to define a collar adapted to fit up inside the nest and hold the bags open when slipped down axially over an upright mandrel to produce a dispenser.

Jorda is the owner of U.S. Pat. No. 4,753,538 which issued on Jun. 28, 1988 which relates to an extruded plastics material net bag, formed by a tubular body which in the flattened state defines two superimposed sheets, in each of which there are two reinforced longitudinal lateral web portions close to the lateral edges of the bag and a reinforced longitudinal central web portion substantially equidistant between the other two; the bag handles are extensions of the lateral web portions and are provided with a weld line at the end thereof while a weld line defines the bottom of the bag. The bag is closed either by way of a fill-form member capable of throttling the mouth of the bag or by two closing appendices, one on each sheet and which extend beyond the bag mouth, being joined together by knotting, stapling or any other means. The special location of the lateral web portions and the existence of the central web portion provide more strength and a greater dimensional stability to the full bag.

However, in spite of the known variety of bags, the inventor has identified a need for improved reusable grocery bags.

### SUMMARY

In accordance with one aspect there is provided a reusable bag that includes a fabric body that has a net structure configured to allow optical inspection of optical product identifiers on or attached to products within the reusable bag. The fabric body generally provides sufficient strength to carry produce or other grocery products. In some embodiments the fabric body may be washable.

In some embodiments, the reusable bag may also include a fastener that is secured to the fabric body to allow produce to be secured within the net structure. The fastener may be durable and washable.

The reusable bag may be made out of a strong, washable fabric that provides visibility into the bag for the viewer. Furthermore the fabric body has at least a portion that allows for barcodes or other optical product identifiers on or attached to the produce to be read or scanned through the net structure. For example, a barcode on a piece of fruit may be scanned through the net structure at a check out while the bag is securely closed by the fastener, thus without removing the piece of fruit from the bag.

In some embodiments, the washable fabric may have at least a portion made of tulle. Generally, tulle provides sufficient strength, visibility of the barcodes, and can be reused and washed.

Some advantages of the embodiments described herein may include, but are not limited to, the ability to reuse the produce bag indefinitely or for a large number of uses, the ability to read barcodes or other optical product identifiers on the produce without having to remove the produce at the check out thereby reducing delay at the check out, the use of washable fabric such as tulle so as to allow sanitary transportation of the produce from grocery store to home, the bag having sufficient strength to accommodate a wide variety of produce and other grocery products that may be available, the environmental benefit of not having to throw away plastic bags into land-fills, reduction of costs to grocery stores as they will not have to provide plastic bags for transporting produce, an inexpensive reusable alternative to conventional plastic bags, and a simple fastener or closure that may allow the user to easily open and close the reusable bag during the shopping process.

According to another aspect, there is provided a reusable grocery bag comprising a fabric body having an interior volume and an opening that provides access to the interior volume. The fabric body includes a plurality of threads oriented and spaced apart so as to form a net structure for securing at least one grocery product within the interior volume. At least a portion of the net structure is sized and shaped to allow an optical product identifier received in the interior volume and on or associated with the at least one grocery product to be optically identified through the net structure using an optical scanner.

At least a portion of the fabric body may be made from tulle.

At least a portion of the fabric body may be air permeable.

The plurality of threads may have a thread size of less than approximately 20 denier. In some embodiments, the plurality of threads may have a thread size of less than approximately 10 denier.

The plurality of threads may have a diameter of less than approximately 50 micrometers. In some embodiments, the plurality of threads may have a diameter of less than approximately 35 micrometers.

The plurality of threads may be spaced apart to provide a thread density of less than approximately 40 threads per inch. In some embodiments, the plurality of threads may be spaced apart to provide a thread density of less than approximately 20 threads per inch.

The fabric body may be made of a washable material.

According to another aspect, there is provided a system for scanning an optical product identifier on or associated with at least one grocery product. The system comprises an optical scanner, a data processor in communication with the optical scanner, and at least one reusable grocery bag. Each reusable grocery bag comprises a fabric body having an interior volume and an opening that provides access to the interior volume. The fabric body includes a plurality of threads oriented and spaced apart so as to form a net structure for securing the least one grocery product within the interior volume. At least a portion of the net structure is sized and shaped to allow the optical product identifier on or associated with the at least one grocery product to be optically identified through the net structure using the optical scanner.

The optical scanner may be configured to scan the optical product identifier through the net structure so as to output product data to the data processor, and the data processor may be configured to associate the product data with the product.

At least one of the optical scanner and the data processor may be configured to account for individual threads that partially cover the optical product identifier.

The optical scanner may have an error tolerance greater than the size or thickness of the individual threads.

At least one of the optical scanner and the data processor may be configured to account for individual threads that partially cover the optical product identifier and that have a thread size between approximately 10-20 denier.

At least one of the optical scanner and the data processor may be configured to account for individual threads that partially cover the optical product identifier and that have a diameter between approximately 35-50 micrometers.

At least one of the optical scanner and the data processor may be configured to account for individual threads that partially cover the optical product identifier and that have a thread density between approximately 20-40 threads per inch.

According to another aspect, there is provided a method of scanning an optical product identifier on or associated with at least one grocery product. The method comprises providing at least one reusable grocery bag. Each reusable grocery bag has a fabric body having an interior volume and an opening that provides access to the interior volume. The fabric body includes a plurality of threads oriented and spaced apart so as to form a net structure for securing the at least one grocery product within the interior volume. At least a portion of the net structure is sized and shaped to allow the optical product identifier on or associated with the at least one grocery product to be optically identified through the net structure using an optical scanner.

The method further comprises placing the product within the interior volume of the reusable bag, and scanning the optical product identifier through the net structure.

The method may further comprise scanning a product image, and accounting for individual threads that partially cover the optical product identifier.

### BRIEF DESCRIPTION OF THE DRAWINGS

Various embodiments will now be described, by way of example only, with reference to the following drawings, in which:

FIG. 1 is a perspective view of a reusable grocery bag according to one embodiment;

FIG. 2 is a perspective view of the reusable bag of FIG. 1;

FIG. 3 is another perspective view of the reusable bag of FIG. 1;

FIG. 4 is another perspective view of the reusable bag of FIG. 1;

FIG. 5 is a profile view of the reusable bag of FIG. 1;

FIG. 6 is another perspective view of the reusable bag of FIG. 1;

FIG. 7 is a profile view of the reusable bag of FIG. 1;

FIG. 8 is a close-up perspective view of a portion of the reusable bag of FIG. 1;

FIG. 9 is a profile view of the net structure of the reusable bag of FIG. 1;

FIG. 10 is a perspective view of a reusable bag according to another embodiment;

FIG. 11 is a schematic diagram of a system for scanning an optical product identifier on a grocery product according to another embodiment; and

FIG. 12 is a flow chart illustrating a method of scanning an optical product identifier on a grocery product according to yet another embodiment.

In the drawings, the various embodiments are illustrated by way of example only. It is to be expressly understood that the description and drawings are only for the purpose of illustration and as an aid to understanding, and are not intended as a definition of the limits of the invention.

### DETAILED DESCRIPTION

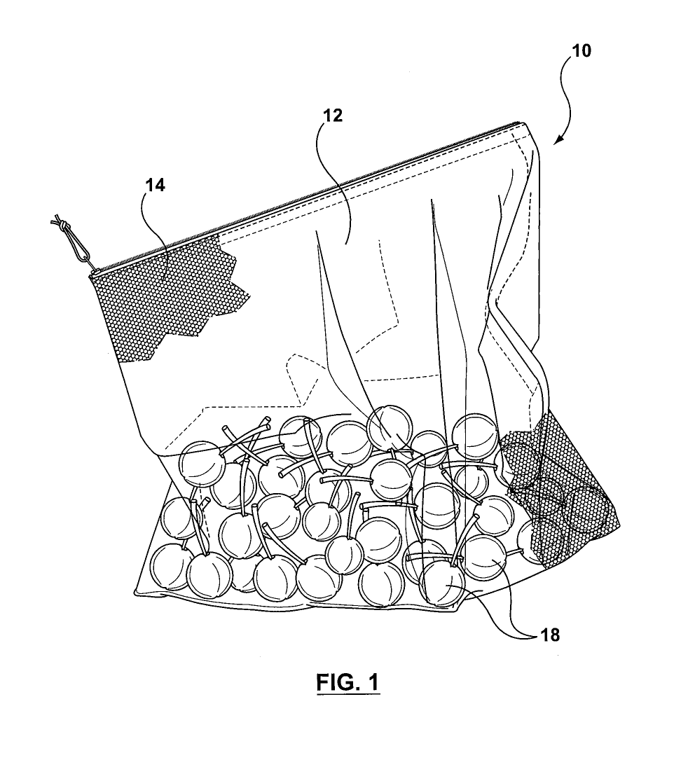

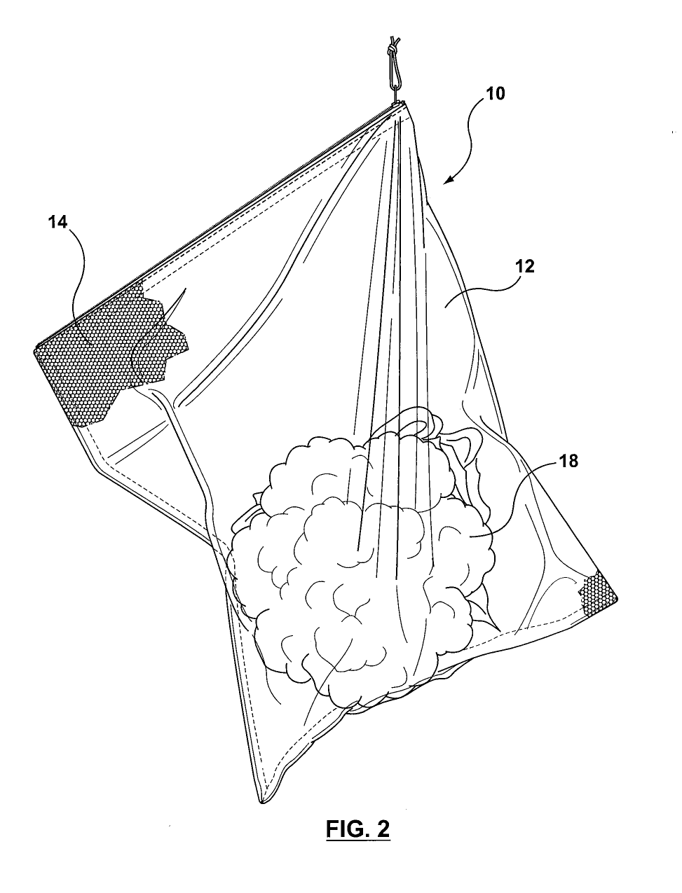

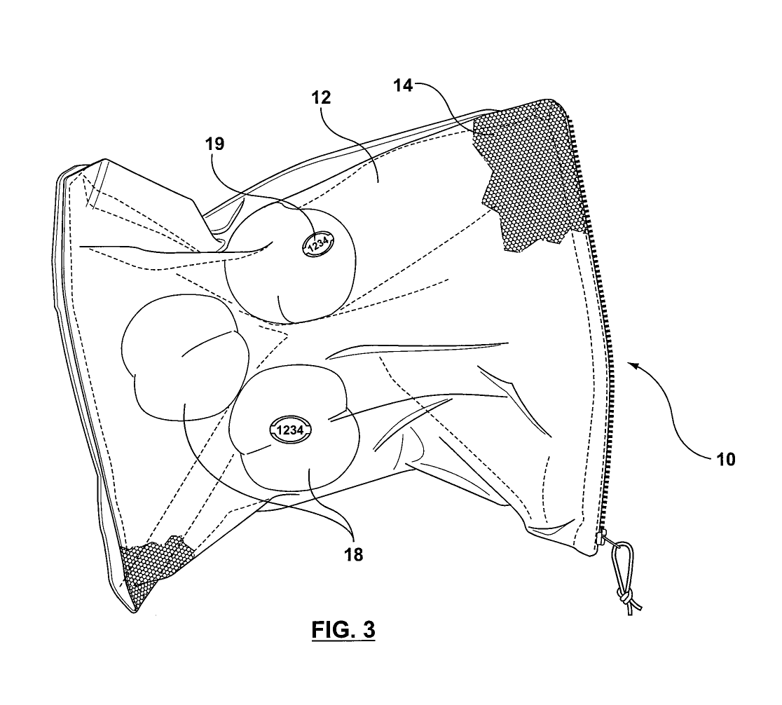

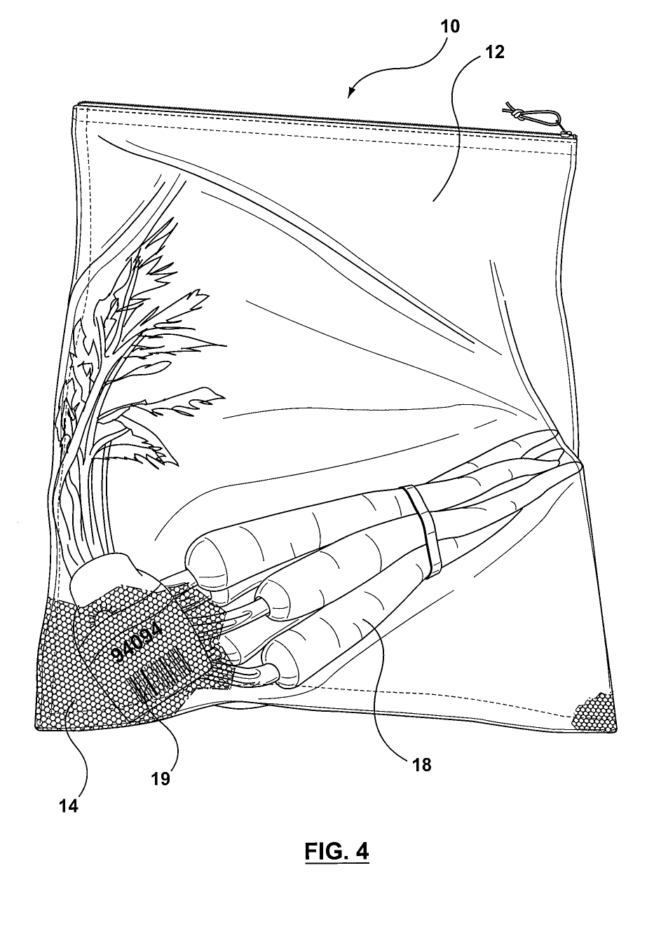

Referring to FIGS. 1 to 4, illustrated therein are several perspective views of a reusable grocery bag 10 made in accordance with one embodiment. The reusable bag 10 generally includes a fabric body 12 having an interior volume and an opening that provides access to the interior volume. For example, a piece of produce 18 or other grocery product may be placed into the interior volume through the opening. Referring to FIGS. 1-4, examples of produce 18 may include cherries (shown in FIG. 1), cauliflower (shown in FIG. 2), apples (shown in FIG. 3) and carrots (shown in FIG. 4), respectively.

The fabric body 12 includes at least a portion having a plurality of threads oriented and spaced apart so as to form a net structure 14 for securing the produce 18. The threads of the net structure 14 are generally configured to allow the produce 18 within the reusable bag 10 to be visible through the panels of the bag 10. For example, as shown in FIGS. 3 and 4, the threads may be configured to allow for optical identification (e.g. scanning using an electronic scanner) of an optical product identifier through the net structure 14, as will be described in more detail below.

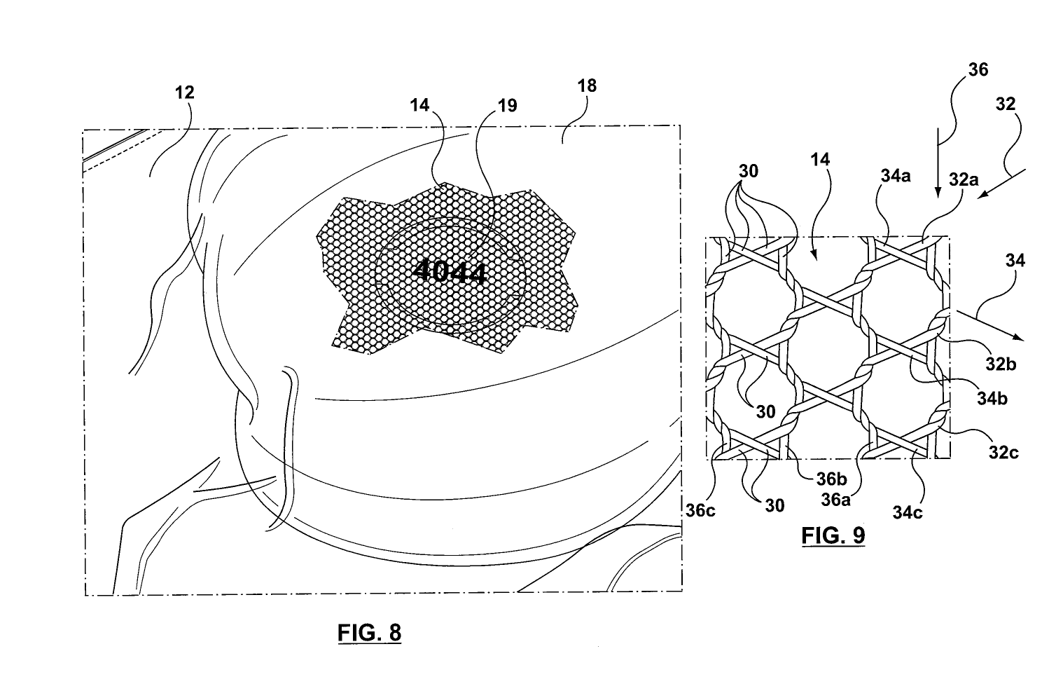

The optical product identifier may be an image, such as a barcode 19 located on the produce 18. In some cases, the barcode 19 may be a one-dimensional barcode on a tag (as shown in FIG. 3) or a two-dimensional barcode (not shown). Alternatively, the optical product identifier may be an alphanumeric label (e.g. “4044”) attached to the produce 18, as shown in FIG. 8, and which may be optically identified (e.g. using character recognition).

In other embodiments, the optical product identifier may be the product itself. In such embodiments, a scanner may capture an image of the product through the net structure 14 (e.g. an image of the cherries shown in FIG. 1), and a computer processor may use image recognition to identify the product in the bag 10.

The fabric body 12 generally provides sufficient strength to carry products, such as produce 18 or other grocery products, within the reusable bag 10. The net structure 14 is also air permeable, and provides breathability through the fabric body 12, which may help keep produce, or other food products, fresh. The fabric body 12 may also be made of a material that is washable so that the bag 10 may be washed for reuse.

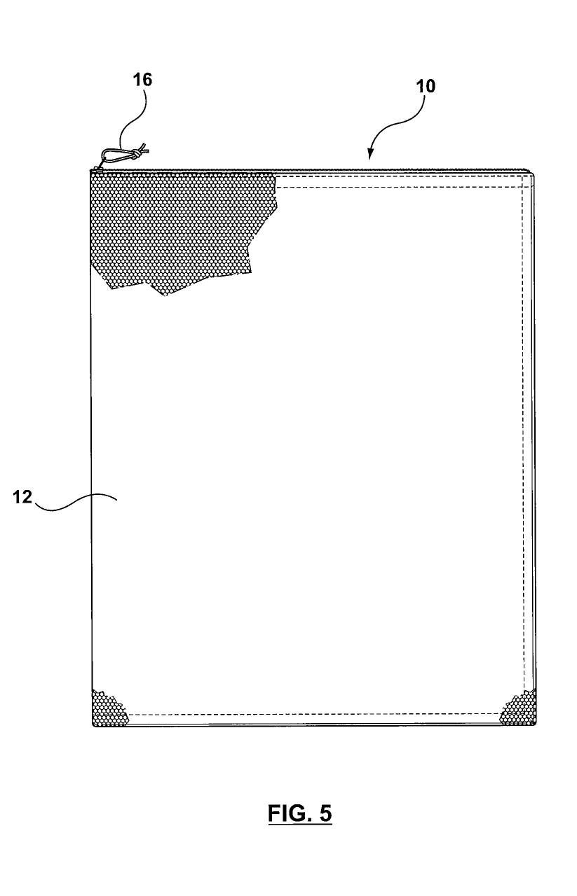

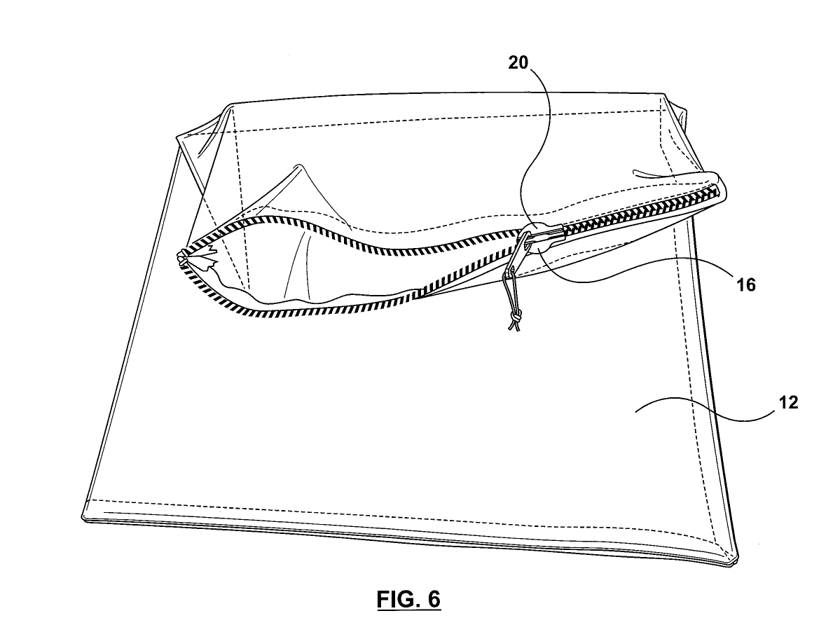

Referring now to FIGS. 5 and 6, the reusable bag 10 may include a fastener 16 that is secured to the fabric body 12. Generally, the fastener 16 may be located at or near the opening in the fabric body 12 so that the reusable bag 10 may be selectively opened and closed. Generally, the fastener 16 can be opened and closed so as to secure the produce 18 within the reusable bag 10. In some embodiments, the fastener 16 may be washable and reusable.

The fastener 16 may be a variety of different mechanisms. For example, the fastener 16 may be a zipper 20 that can be engaged to secure the produce 18 inside the reusable bag 10. In other embodiments, the fastener 16 may include a hook and loop arrangement (e.g. Velcro™), a drawstring arrangement, a snap closure system, a Ziploc™-style fastener, or another suitable fastener.

The fastener 16 may be durable. For example, the fastener 16 may be configured to match the durability of the fabric body 12. Moreover the fastener 16 generally provides sufficient strength so as to securely hold the produce 18 or other grocery products within the reusable bag 10 such that the produce 18 does not fall out during use.

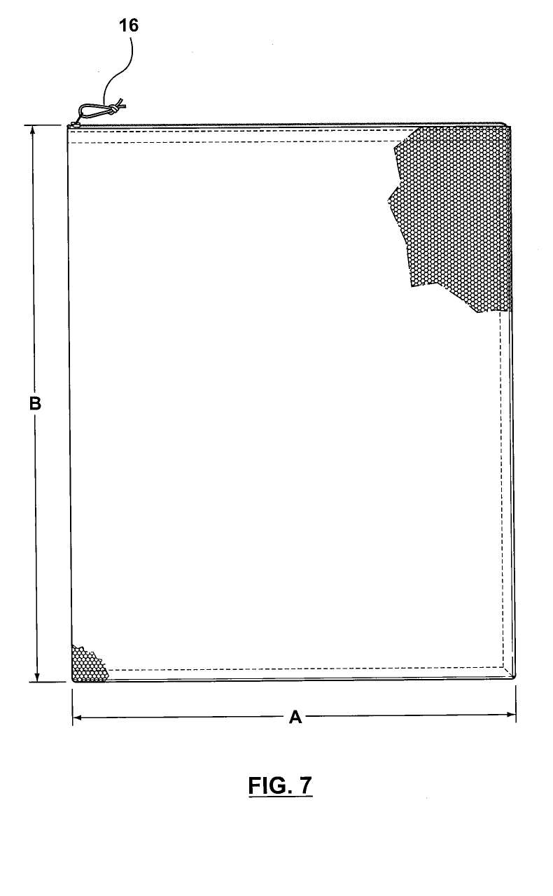

Referring to FIG. 7, the reusable bag 10 as shown may be generally rectangular in shape and may have a width A and a length B. Generally, the width A and length B may be selected so that a desired size and number of grocery products may be received within the bag 10. In other embodiments, the reusable bag 10 may have other shapes (e.g. spherical, elliptical, cylindrical, etc.).

Referring now to FIGS. 8 and 9, the fabric body 12 will be described in further detail. As mentioned, the fabric body 12 generally includes at least a portion having threads that form a net structure 14 with a weave suitable for viewing the produce 18 within the reusable bag 10 so that an optical product identifier (such as a barcode 19), which may be secured to the produce 18 (e.g. via a sticker), can be optically identified (e.g. scanned) through the fabric body 12. For example, the barcode 19 may be scanned through the net structure 14 by a barcode scanner at a check out within a grocery store.

The visibility through the fabric body 12 of the reusable bag 10 allows for the produce 18 to be scanned and checked out generally without removing the produce 18 from the reusable bag 10 to scan or view the barcode 19 or other optical product identifier. This tends to save time at the check out line and may allow for smoother transactions.

In some embodiments, at least a portion of the fabric body 12 may be made from tulle fabric, which tends to provide the desired level of visibility for viewing and scanning due to its wide weave and small thread size. Moreover tulle fabric also tends to provide sufficient strength to hold many types of produce 18 securely without the net structure 14 breaking. Tulle fabric also tends to be very durable and can withstand repeated washings while maintaining its structure and strength.

FIG. 9 shows an exemplary weave for the net structure 14 of one type of tulle fabric. The net structure 14 generally includes a plurality of threads 30 woven together. For example, the threads 30 may include a first set of threads 32a, 32b, 32c extending along a first direction 32 generally parallel to each other, a second set of threads 34a, 34b, 34c extending along a second direction 34 generally parallel to each other, and a third set of threads, 36a, 36b, 36c extending along a third direction 36 generally parallel to each other. The first direction 32, second direction 34 and third direction 36 may be generally planar and non-parallel. For example, as illustrated, the first set of threads 32a, 32b, 32c are generally inclined 60-degrees clockwise relative to the third set of threads 36a, 36b, 36c, and the second set of threads 34a, 34b, 34c are generally inclined 60-degrees counter-clockwise relative to the third set of threads 36a, 36b, 36c.

The first set of threads 32a, 32b, 32c are generally positioned on top of the second set of threads 34a, 34b, 34c, while the third set of threads 36a, 36b, 36c are interwoven between the first set of threads 32a, 32b, 32c and the second set of threads 34a, 34b, 34c. For example, thread 36a extends along the third direction 36 and wraps around thread 32a one time and then continues to extend along the third direction 36. The thread 36a then wraps around thread 34b one time and continues along the third direction 36. The thread 36a continues to wrap around each subsequent thread that it crosses along the third direction 35 (i.e. thread 32b and then thread 34c). Interweaving the threads 30 in this fashion tends to provide sufficient strength for the reusable bag 10 while maintaining sufficient visibility into the interior volume of the reusable bag 10 so that an optical product identifier can be optically identified.

Generally, tulle fabric tends to be made from threads that are relatively thin compared to the spacing between adjacent threads. For example, threads in a tulle fabric may have a thread size of less than 20 denier (in some cases approximately 10-20 denier), which generally allows an optical product identifier to be scanned through the net structure 14. For example, a barcode scanner may be able to scan a barcode 19 even if the barcode 19 is partially blocked by threads having a size of less than approximately 20 denier.

Furthermore, there tends to be a higher probability of accurately scanning the barcode if the threads have a size of less than approximately 10 denier.

By contrast, the inventor has discovered that prior art reusable grocery bags tended to have very thick fibers that were often closely spaced together. These thick fibers tend to interfere with the optical characteristics of an optical product identifier (e.g. a barcode 19) and as a result known prior art grocery bags are generally not capable or suitable for use with optical scanners.

In some embodiments, the tulle fabric may be nylon. In such embodiments, the threads may have a diameter of approximately 35-50 micrometers. Generally, a barcode scanner can scan a barcode even if the barcode is partially blocked by threads where each thread has a diameter of less than approximately 50 micrometers.

Furthermore, there tends to be a higher probability of accurately scanning the barcode if the threads have a diameter of less than approximately 35 micrometers.

Furthermore, in some embodiments the threads in the tulle fabric may have a thread density of approximately 20-40 threads per inch. Generally, a barcode scanner can scan a barcode even if the barcode is partially blocked by threads having a thread density of less than approximately 40 threads per inch.

Furthermore, there tends to be a higher probability of scanning the barcode if the threads have a thread density of less than approximately 20 threads per inch.

The size of the reusable bag 10 may vary depending on the requirements of the produce 18 or other grocery product that are to be placed within the reusable bag 10. In some embodiments, there may be more than one size available for the reusable bag 10. The different sizes of the reusable bags 10 may be utilized according to the different types of produce 18 being packed.

In some embodiments, the fabric body 12 may be washable. Making the reusable bag 10 from a washable fabric body 12 tends to allow for more sanitary transportation of the produce 18. For example, a spill or mess either within or on the outside of the reusable bag 10 may be removed by simply washing the reusable bag 10 in a washing machine, hand washing, or using another washing technique, and then drying the reusable bag 10 (since the bags 10 are air permeable).

The washable fabric body 12 can therefore be reused many times, and possibly indefinitely. In contrast, when using traditional plastic bags to transport produce 18, if there is a spill or mess within the plastic bag or on the outside the plastic bag, the plastic bag is typically thrown out as it may be difficult to clean and then dry the bag (e.g. since the plastic bags are not normally air permeable, they are difficult to dry). Even without a spill or mess, these plastic bags are rarely reused by consumers and are typically thrown out when the produce 18 is removed therefrom.

The costs of manufacturing the reusable bag 10 are generally minimal because production tends to be relatively simple, while the benefits of having the long-term use of the reusable bag 10 tend to be more significant than the manufacturing costs. This comparison between production costs and long-term use may be particularly relevant to grocery stores because they typically provide plastic bags to consumers for transporting their produce 18. As mentioned, these plastic bags are typically thrown out by consumers and tend to be a significant expense for grocery stores. Accordingly, providing plastic bag may represent a higher overall cost to the grocery store in comparison to using the reusable bags 10 described herein.

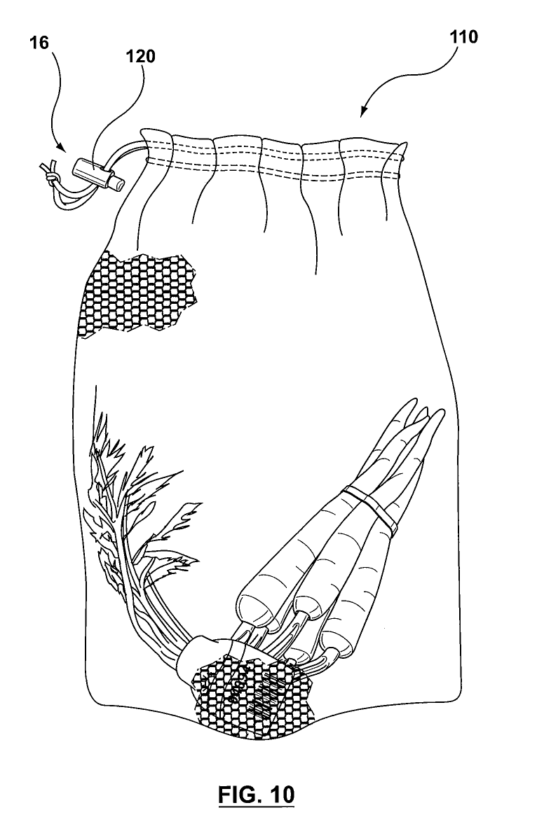

Referring to FIG. 10, illustrated therein is a reusable bag 110 made in accordance with another embodiment. The reusable bag 110 is generally similar to the reusable bag 10 except that the fastener 16 includes a drawstring 120. The drawstring 120 tends to be cheaper than the zipper and may provide easier or quicker opening and closing of the reusable bag 110.

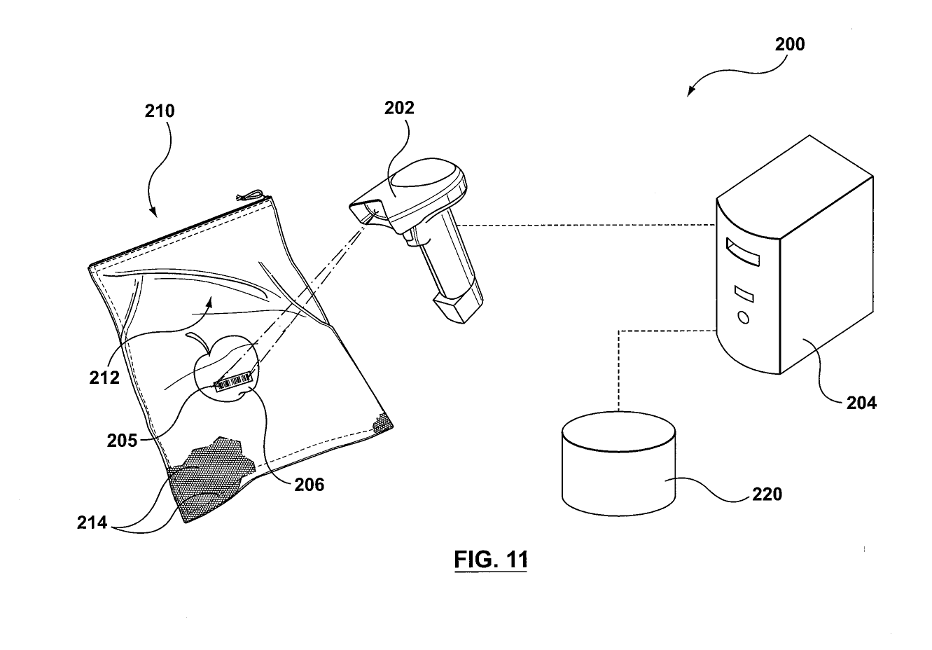

Referring to FIG. 11, illustrated therein is a system 200 for scanning a barcode or other optical product identifier on a grocery product according to another embodiment. The system 200 generally includes an optical scanner 202 (e.g. a barcode scanner) and a data processor 204 in communication with the optical scanner 202. For example, the optical scanner 202 may be in wireless or wired communication with the data processor 204.

The system 200 is generally used to optically scan an optical product identifier 205 (e.g. a barcode) located on or associated with a product 206 located within a reusable bag 210 (which may be the reusable bags 10, 110 as described above). The reusable bag 210 generally includes a fabric body 212 that includes a plurality of threads so as to form a net structure 214. At least a portion of the threads are configured to allow scanning of the product identifier 205 through the net structure 214 using the optical scanner 202. For example, the threads may be sized and spaced as described above where the bag 210 has at least a portion made of tulle.

The optical scanner 202 is generally configured to scan the optical product identifier 205 through the net structure 214 so as to output product data (e.g. barcode data) to the data processor 204. For example, the product data may include a barcode image, or a barcode number.

In some embodiments, the optical scanner 202 may be configured to account for individual threads that at least partially cover the optical product identifier 205, such as individual threads having a particular size and spacing. For example, the optical scanner 202 may have a resolution sufficient to account for threads that at least partially cover the optical product identifier 205, where the thread size is between approximately 10-20 denier, that have a diameter between approximately 35-50 micrometers, and/or have a thread density between approximately 20-40 threads per inch.

The optical scanner 202 may be configured to account for individual threads in different ways. For example, the optical scanner 202 may have an error tolerance for scanning barcodes or other optical product identifiers that is greater than the size of the threads in the net structure 214. In such embodiments, when the optical scanner 202 scans an optical product identifier 205, the optical scanner 202 may generate an optical image that does not include the individual threads.

In other words, the optical scanner 202 may not “see” individual threads that have a thread size or diameter within the error tolerance of the optical scanner 202. Accordingly, the system 200 may be able to scan the optical product identifier 205 despite the presence of individual threads that partially cover the optical product identifier 205, provided the individual threads are spaced sufficiently far apart so that the optical product identifier 205 may be read by the optical scanner 202.

In other embodiments, the optical scanner 202 may be configured to account for threads having a particular size and spacing. For example, the optical scanner 202 may scan a product image that includes the individual threads and then remove the individual threads from the image (e.g. using image processing techniques). After removing the individual threads, the optical scanner 202 may generate and output the product data to the data processor 204.

In some embodiments, the optical scanner 202 may output the image with the individual threads as the product data such that the data processor 204 accounts for threads having a particular size. For example, the data processor 204 may perform image processing to remove the individual threads from the image to identify the product in the bag 210.

The data processor 204 receives the product data and is generally configured to associate the product data with the particular product 206 to identify the particular product 206 and/or determine particular data for that product 206. For example, the processor 204 may determine the price of the particular product 206 in the bag 210, such as a price per unit or a price per unit of weight for the product.

In some embodiments, the association between the product data and the product 206 may be stored in a memory within the data processor 204 or in a separate database or other data storage device 220 that is in communication with the data processor 204.

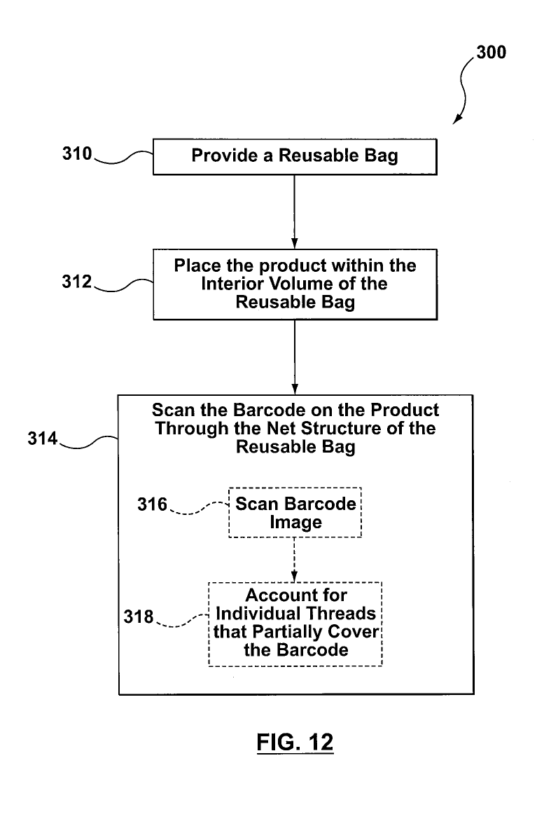

Referring to FIG. 12, illustrated therein is a method 300 of scanning an optical product identifier (e.g. a barcode) on a product according to another embodiment.

Step 310 includes providing a reusable bag comprising a fabric body having an interior volume, and an opening that provides access to the interior volume. The fabric body includes a plurality of threads oriented and spaced apart so as to form a net structure, with at least a portion of the net structure configured so that an optical product identifier (e.g. barcode) on or associated with a product in the bag can be scanned through the net structure by an optical scanner (e.g. a barcode reader). For example, the reusable bag may be any one of the reusable bags 10, 110, 210 described above.

Step 312 includes placing the product within the interior volume of the reusable bag. For example, a piece of produce may be placed within the interior volume.

Step 314 includes scanning the optical product identifier (e.g. barcode) on the product through the net structure of the reusable bag. For example, a barcode may be scanned using a barcode scanning system, such as the system 200 described above.

In some embodiments, step 314 may include sub-steps 316 and 318. Step 316 includes scanning a barcode image, for example, using a barcode scanner. Step 318 includes accounting for individual threads that partially cover that barcode. For example, a barcode scanner or a data processor may account for the individual threads as described above. In some embodiments step 318 may include accounting for individual threads that have a thread size between approximately 10-20 denier. In some embodiments step 318 may include accounting for individual threads that have a diameter between approximately 35-50 micrometers. In some embodiments step 318 may include accounting for individual threads that have a thread density between approximately 20-40 threads per inch.

While the above description includes a number of exemplary embodiments, many modifications, substitutions, changes and equivalents can be implemented by those of ordinary skill in the art without departing from the spirit and scope of the embodiments described herein.

1. A reusable grocery bag, comprising:
a) a fabric body having an interior volume and an opening that provides access to the interior volume;
b) the fabric body including a plurality of threads oriented and spaced apart so as to form a net structure for securing at least one grocery product within the interior volume;
c) wherein at least a portion of the net structure is sized and shaped to allow an optical product identifier received in the interior volume and on or associated with the at least one grocery product to be optically identified through the net structure using an optical scanner.

2. The reusable bag of claim 1, wherein at least a portion of the fabric body is made from tulle.

3. The reusable bag of claim 1, wherein at least a portion of the fabric body is air permeable.

4. The reusable bag of claim 1, wherein the plurality of threads have a thread size of less than approximately 20 denier.

5. The reusable bag of claim 1, wherein the plurality of threads have a thread size of less than approximately 10 denier.

6. The reusable bag of claim 1, wherein the plurality of threads have a diameter of less than approximately 50 micrometers.

7. The reusable bag of claim 1, wherein the plurality of threads have a diameter of less than approximately 35 micrometers.

8. The reusable bag of claim 1, wherein the plurality of threads are spaced apart to provide a thread density of less than approximately 40 threads per inch.

9. The reusable bag of claim 1, wherein the plurality of threads are spaced apart to provide a thread density of less than approximately 20 threads per inch.

10. The reusable bag of claim 1, wherein the fabric body is made of a washable material.

11. A system for scanning an optical product identifier on or associated with at least one grocery product, the system comprising:
a) an optical scanner;
b) a data processor in communication with the optical scanner; and
c) at least one reusable grocery bag, each reusable grocery bag comprising:
i) a fabric body having an interior volume and an opening that provides access to the interior volume, the fabric body including a plurality of threads oriented and spaced apart so as to form a net structure for securing the least one grocery product within the interior volume;
ii) wherein at least a portion of the net structure is sized and shaped to allow the optical product identifier on or associated with the at least one grocery product to be optically identified through the net structure using the optical scanner.

12. The system of claim 11, wherein the optical scanner is configured to scan the optical product identifier through the net structure so as to output product data to the data processor, and the data processor is configured to associate the product data with the product.

13. The system of claim 11, wherein at least one of the optical scanner and the data processor are configured to account for individual threads that partially cover the optical product identifier.

14. The system of claim 11, wherein the optical scanner has an error tolerance greater than the size or thickness of the individual threads.

15. The system of claim 11, wherein at least one of the optical scanner and the data processor are configured to account for individual threads that partially cover the optical product identifier and that have a thread size between approximately 10-20 denier.

16. The system of claim 11, wherein at least one of the optical scanner and the data processor are configured to account for individual threads that partially cover the optical product identifier and that have a diameter between approximately 35-50 micrometers.

17. The system of claim 11, wherein at least one of the optical scanner and the data processor are configured to account for individual threads that partially cover the optical product identifier and that have a thread density between approximately 20-40 threads per inch.

18. A method of scanning an optical product identifier on or associated with at least one grocery product, the method comprising:
a) providing at least one reusable grocery bag, each reusable grocery bag having:
i) a fabric body having an interior volume and an opening that provides access to the interior volume, the fabric body including a plurality of threads oriented and spaced apart so as to form a net structure for securing the at least one grocery product within the interior volume;
ii) wherein at least a portion of the net structure is sized and shaped to allow the optical product identifier on or associated with the at least one grocery product to be optically identified through the net structure using an optical scanner;
b) placing the product within the interior volume of the reusable bag; and
c) scanning the optical product identifier through the net structure.

19. The method of claim 18, further comprising:
a) scanning a product image; and
b) accounting for individual threads that partially cover the optical product identifier.
